(19) United States
(12) Patent Application Publication
(10) Pub. No.: US 2024/0418297 A1
(43) Pub. Date: Dec. 19, 2024

(54) APPARATUS FOR FACILITATING SAFE MANAGEMENT OF ELECTRICAL CORDS

(71) Applicant: Thomas Arthur Guilford, Tierra Verde, FL (US)

(72) Inventor: Thomas Arthur Guilford, Tierra Verde, FL (US)

(21) Appl. No.: 18/746,005

(22) Filed: Jun. 17, 2024

Related U.S. Application Data
(63) Continuation-in-part of application No. 29/879,960, filed on Jul. 14, 2023.
(60) Provisional application No. 63/508,466, filed on Jun. 15, 2023.

(51) Int. Cl. F16L 3/06; H02G 3/04

(52) U.S. Cl. CPC F16L 3/06; H02G 3/0456

(57) ABSTRACT

An apparatus for managing electrical cords and wires is disclosed. The apparatus is bent to form a hook shaped apparatus. The apparatus is lightweight and bears a plurality of intersecting ribs which create a pocket patterned device. The pocket pattern formed by the ribs is necessary for engineering the apparatus and provides a lightweight hook that will maintain the ease of which cords can be managed. The apparatus bears a threaded aperture, allowing a large shaft or screw to be inserted so that the hook can be used while hanging screw. The apparatus further comes with a large magnet which has a plurality of holes, allowing the device to be screwed onto a surface.

### FIELD OF THE INVENTION

The present invention relates generally to the field of installation of electric cables or lines. More specifically, the present invention is an apparatus for facilitating safe management of electrical cords.

### BACKGROUND OF THE INVENTION

The field of installation of electric cables or lines is technologically important to several industries, business organizations, and/or individuals. In particular, the use of installation of electric cables or lines is prevalent for apparatuses for facilitating safe management of electrical cords.

Electrical cords or cables should be handled in a manner that should not cause damage. Flexible cords should not be fastened with staples or otherwise hung in a way that may damage the outer jacket or insulation.

Existing techniques for facilitating the safe management of electrical cords are deficient with regard to several aspects. For instance, current technologies do not provide a suitable way of handling electrical cords to reduce the chances of damage and entangling of the electrical cords during construction. Furthermore, current technologies do not provide safe handling of electrical cords to prevent accidents.

Therefore, there is a need for an improved apparatus for facilitating safe management of electrical cords that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, an apparatus for facilitating a safe management of electrical cords is disclosed. Accordingly, the apparatus includes a body. Further, the body may be discontinuously curvedly shaped between a first end of the body and a second end of the body defining an interior space. Further, the body may include an opening defined between the first end and the second end leading into the interior space. Further, the apparatus may include an attachment component disposed on the second end of the body. Further, the attachment component may be configured for attaching the apparatus to a surface such as a wall, a ceiling, etc. Further, the interior space may receive a portion of at least one cord such as at least one electrical cord through the opening.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an isometric plan view of my cord management hook showing my new design;

FIG. 2 is a left view of the present invention.

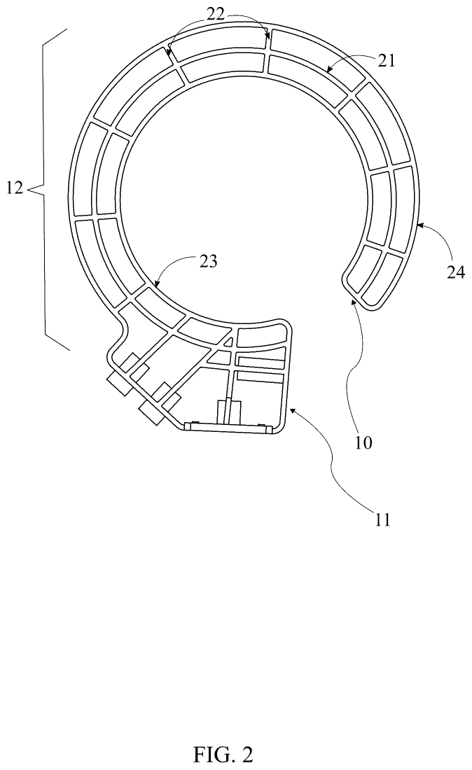

FIG. 3 is a right view of the present invention.

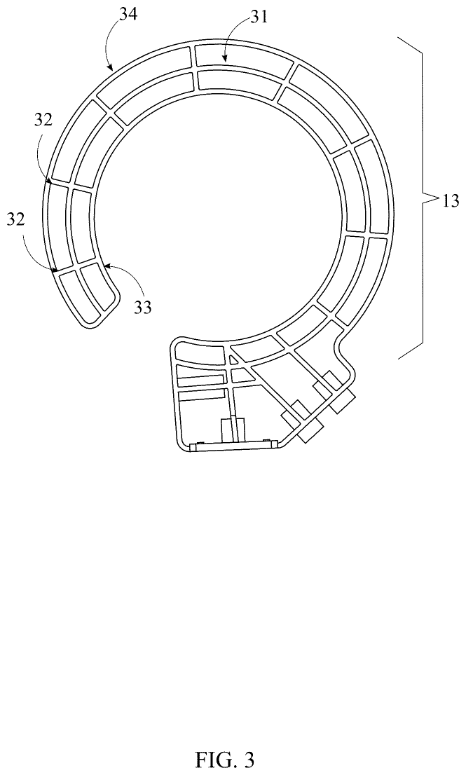

FIG. 4 is a top view of the present invention.

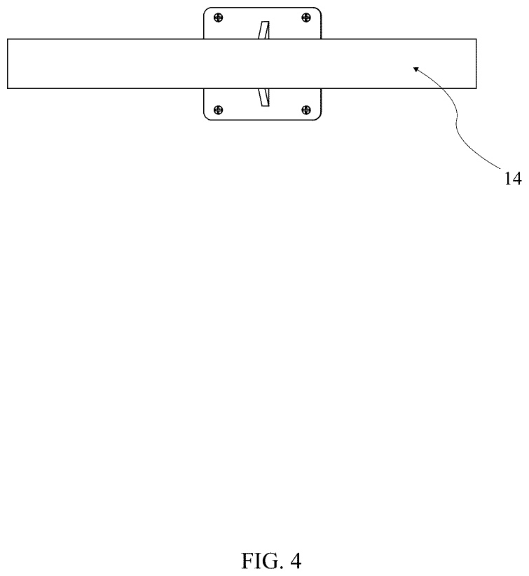

FIG. 5 is a bottom view of the present invention.

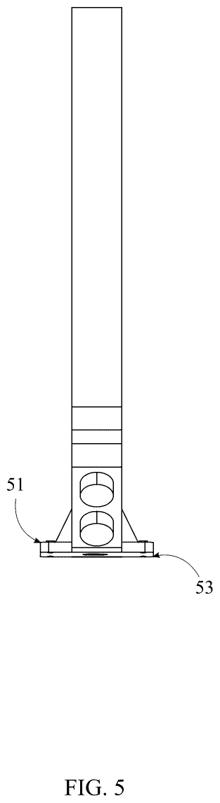

FIG. 6 is a front view of the present invention.

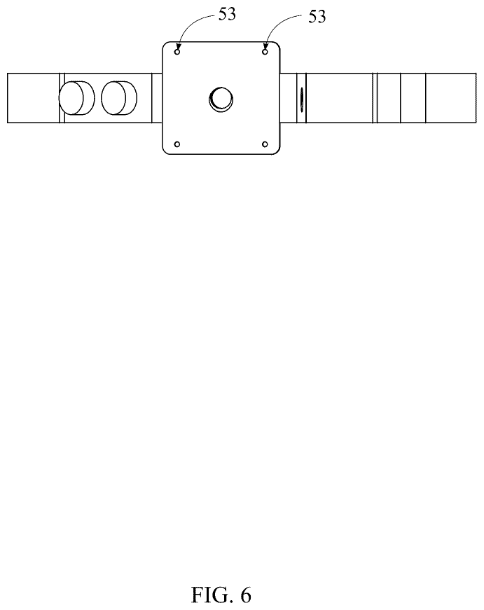

FIG. 7 is a rear view of the present invention.

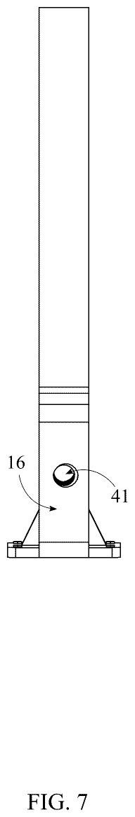

FIG. 8 is a bottom-rear-left perspective view of the present invention.

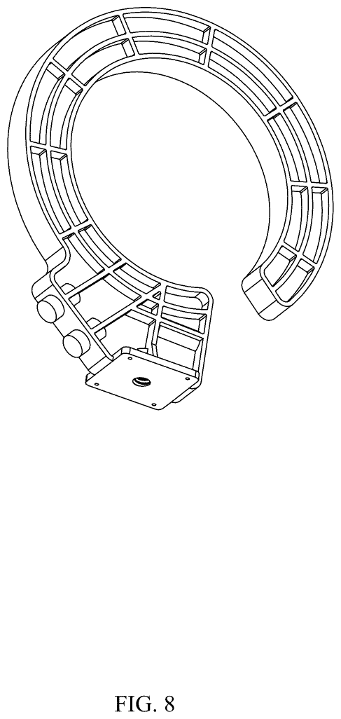

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of an apparatus for facilitating a safe management of electrical cords, embodiments of the present disclosure are not limited to use only in this context.

### Overview

The present disclosure describes an apparatus for facilitating safe management of electrical cords. Further, the apparatus may be designed to provide a non-conductive safe way to manage electrical cords during construction activities or during service work being performed. Further, the apparatus may transition into a permanent solution to low-voltage cable installation.

Further, the apparatus may work by using current construction materials and adding a non-conductive way to route and manage cords to ensure meeting OSHA regulations and upholding project safety. The apparatus is designed to provide damage-proof handling of cords by eliminating fastening the cords with staples or hanging the cords in a way that may damage an outer jacket or insulation of the cords. The apparatus may be non-conductive. In some embodiments, the apparatus may be made by injection-molding plastic into a hook to be either hung off a ⅜″ threaded rod in different configurations. In other embodiments, the apparatus may include a strong magnet 52 built into the apparatus to allow for use in finished construction situations. Additionally, the apparatus may be utilized with a threaded rod, beam clamps, and drop-in anchors.

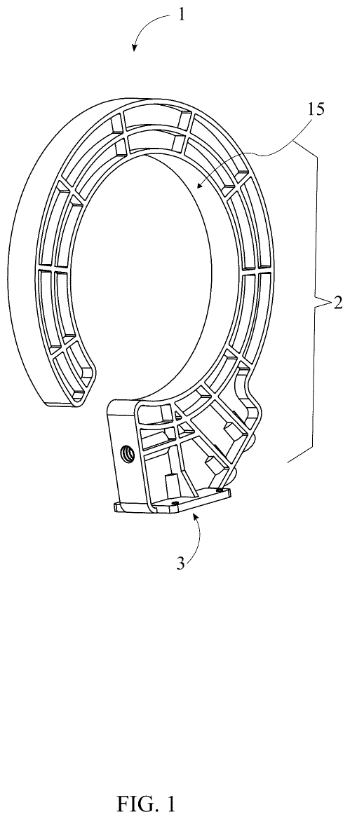

FIG. 1 is a perspective view of an apparatus for facilitating a safe management of electrical cords, in accordance with some embodiments. Accordingly, the apparatus includes a body 2 and a base 3. The body 2 is discontinuously curvedly shaped between a first end of the body 2 and a second end of the body 2 forming a hook-shaped body 2 which defines an interior space. The body 2 includes an opening defined between the first end and the second end leading into the interior space. The base 3 also serves as attachment component which is configured for attaching the apparatus to a surface such as a wall, a ceiling, etc. Further, the interior space may receive a portion of at least one cord such as at least one electrical cord through the opening.

The body 2 comprises a first end and a second end and the body 2 also bears a front face 12 and a rear face 13. The body 2 comprises a first rib 21 and a second rib 31. The first rib 21 and second rib 31 traverse the length of the front face 12 and rear face 13 respectively. The front face 12 compromise and interior edge 23 and an external edge 24. Similarly, the rear face 13 comprises an interior edge 33 and an external edge 34. The external edges are the edge that is located internal to the open space. The external edges are longer in length than the internal edges. This is due to the curved nature of the body 2 which forms the hook shape.

The external edge 24 of the front face 12 and the external edge 34 of the rear face 13 are connected by an outward panel 14 while the internal edge 23 of the front face 12 and the internal edge 33 of the rear face 13 being connected by an inward panel. The body 2 has a plurality of secondary frontal ribs 22 and a plurality of secondary rear ribs 32. These secondary ribs are to provide added support for the apparatus for cord management. Each of plurality of secondary rear ribs 32 extends from the external edge 34 of the rear face 13 to the internal edge 33 of the rear face 13. Further, each of the plurality of secondary front ribs 22 extends from the external edge 24 of the front face 12 to the internal edge 23 of the front face 12.

Each of the plurality of secondary front ribs 22 are spaced equally around the front face 12 from the first end to the second end and each of the plurality of secondary rear ribs 32 are spaced across the rear from the first end to the second end. The secondary ribs combined with the first rib 21 and second rib 31 create a square pocket pattern. This pocket pattern allows for bulk to be removed allowing the apparatus to be lightweight and the ribs provided stability to the hook when in use.

A connection panel 16 is positioned between the outward panel 14 and the internal panel 15 at the second end of the body 2. Located centrally on the connection panel 16 is a threaded aperture 41. This threading allows a shaft to be used to hang the hook from in certain conditions such as on a construction site. The base 3 is located at the second end of the body 2 and the base 3 is positioned between the outward panel 14 and the connection panel 16.

The base 3 comprises a mounting plate 51 and a panel. The base 3 further comprises a plurality of attachment holes 53 and a first support rib 54 and second support rib 55. The attachment holes allow for a screw, bolt, or nut to be used to mount the apparatus to any stationary flat surface. The mounting plate 51 is centrally positioned on top of the magnet 52. Each of the plurality of attachment holes 53 traversing through the mounting plate 51 and the magnet 52. This is necessary to allow the screw to fully piece the base 3 and secure it to any surface. Each of the plurality of attachment holes 53 are perimetrically positioned about the top surface of the base 3. In the preferred embodiment, there is a hole in each corner of the base 3. The first support rib 54 is connected from the internal edge 23 of the front face 12 and the mounting plate 51 and the second support rib 55 is connected from the internal edge 33 of the rear face 13 and the mounting plate 51.

Further, in some embodiments, the apparatus may include a shaft, as shown in FIG. 9 and FIG. 10, extending between a first shaft end and a second shaft end. Further, the shaft may be removably coupled with the body 2 at the first shaft end and the second end. Further, the shaft may include a shaft attachment component disposed at the second shaft end. Further, the shaft may be removably attachable to the surface at the second shaft end using the shaft attachment component.

Although the invention has been explained in relation to its preferred embodiment, it is to be understood that many other possible modifications and variations can be made without departing from the spirit and scope of the invention.

What is claimed is:

1. An apparatus for cord management comprising:
a body;
a base;
the body having a first end and a second end;
the body having a front face and a rear face;
the body comprising a first rib and a second rib;
the first rib traversing the length of the front face; and
the second rib traversing the length of the rear face.

2. The apparatus for cord management as in claim 1 further comprising:
the front face comprising and interior edge and external edge;
the rear face comprising an internal edge and an external edge; and
the external edge being longer in length than the internal edge.

3. The apparatus for cord management as in claim 2 further comprising:
the external edge of the front face and the external edge of the rear face being connected by an outward panel; and
the internal edge of the front face and the internal edge of the rear face being connected by an inward panel.

4. The apparatus for cord management as claimed in claim 1 further comprising:
the body further comprising a plurality of secondary frontal ribs and a plurality of secondary rear ribs;
each of plurality of secondary rear ribs extending from the external edge of the rear face to the internal edge of the rear face; and
each of the plurality of secondary front ribs extending from the external edge of the front face to the internal edge of the front face;
each of the plurality of secondary front ribs being spaced across the front face from the first end to the second end; and
each of the plurality of secondary rear ribs being spaced across the rear from the first end to the second end.

5. The apparatus for cord management as in claim 3 further comprising:
a connection panel is positioned between the outward panel and the internal panel at the second end of the body;
a threaded aperture is centrally located on the connection panel.

6. The apparatus for cord management as in claim 5 further comprising:
the base being located at the second end of the body;
the base being positioned between the outward panel and the connection panel.

7. The apparatus for cord management as in claim 1 further comprising:
the base comprising a mounting plate and a magnet;
the base further comprising a plurality of attachment holes and a first support rib and second support rib;
the mounting plate being centrally positioned on top of the magnet;
each of the plurality of attachment holes traversing through the mounting plate and the magnet; and
each of the plurality of attachment holes being perimetrically positioned about the top surface of the base.

8. The apparatus for cord management as in claim 1 further comprising:
the first support rib being connected from the internal edge of the front face and the mounting plate; and
the second support rib being connected from the internal edge of the rear face and the mounting plate.

9. An apparatus for cord management comprising:
a body;
a base;
the body having a first end and a second end;
the body having a front face and a rear face;
the body comprising a first rib and a second rib;
the first rib traversing the length of the front face;
the second rib traversing the length of the rear face; and
the front face comprising and interior edge and external edge.

10. The apparatus for cord management as in claim 9 further comprising:
the external edge of the front face and the external edge of the rear face being connected by an outward panel;
the internal edge of the front face and the internal edge of the rear face being connected by an inward panel;
the rear face comprising an internal edge and an external edge; and
the external edge being longer in length than the internal edge.

11. The apparatus for cord management as claimed in claim 10 further comprising:
the body further comprising a plurality of secondary frontal ribs and a plurality of secondary rear ribs;
each of plurality of secondary rear ribs extending from the external edge of the rear face to the internal edge of the rear face; and
each of the plurality of secondary front ribs extending from the external edge of the front face to the internal edge of the front face;
each of the plurality of secondary front ribs being spaced across the front face from the first end to the second end;
each of the plurality of secondary rear ribs being spaced across the rear from the first end to the second end; and
a connection panel is positioned between the outward panel and the internal panel at the second end of the body.

12. The apparatus for cord management as in claim 11 further comprising:
a threaded aperture is centrally located on the connection panel;
the base being located at the second end of the body; and
the base being positioned between the outward panel and the connection panel.

13. The apparatus for cord management as in claim 1 further comprising:
the base comprising a mounting plate and a magnet;
the base further comprising a plurality of attachment holes and a first support rib and second support rib;
the mounting plate being centrally positioned on top of the magnet;
each of the plurality of attachment holes traversing through the mounting plate and the magnet;
each of the plurality of attachment holes being perimetrically positioned about the top surface of the base;
the first support rib being connected from the internal edge of the front face and the mounting plate; and
the second support rib being connected from the internal edge of the rear face and the mounting plate.

14. An apparatus for cord management comprising:
a body;
a base;
the body having a first end and a second end;
the body having a front face and a rear face;
the body comprising a first rib and a second rib;
the first rib traversing the length of the front face;
the second rib traversing the length of the rear face;
the front face comprising and interior edge and external edge;
the rear face comprising an internal edge and an external edge; and
the external edge being longer in length than the internal edge.

15. The apparatus for cord management as in claim 14 further comprising:
the external edge of the front face and the external edge of the rear face being connected by an outward panel;
the internal edge of the front face and the internal edge of the rear face being connected by an inward panel;
the body further comprising a plurality of secondary frontal ribs and a plurality of secondary rear ribs;
each of plurality of secondary rear ribs extending from the external edge of the rear face to the internal edge of the rear face;
each of the plurality of secondary front ribs extending from the external edge of the front face to the internal edge of the front face;
each of the plurality of secondary front ribs being spaced across the front face from the first end to the second end; and
each of the plurality of secondary rear ribs being spaced across the rear from the first end to the second end.

16. The apparatus for cord management as in claim 15 further comprising:
a connection panel is positioned between the outward panel and the internal panel at the second end of the body;
a threaded aperture is centrally located on the connection panel;
the base being located at the second end of the body; and
the base being positioned between the outward panel and the connection panel.

17. The apparatus for cord management as in claim 14 further comprising:
the base comprising a mounting plate and a magnet;
the base further comprising a plurality of attachment holes and a first support rib and second support rib;
the mounting plate being centrally positioned on top of the magnet;
each of the plurality of attachment holes traversing through the mounting plate and the magnet;
each of the plurality of attachment holes being perimetrically positioned about the top surface of the base;
the first support rib being connected from the internal edge of the front face and the mounting plate; and
the second support rib being connected from the internal edge of the rear face and the mounting plate.
